(19) United States
(12) Patent Application Publication
(10) Pub. No.: US 2026/0264549 A1
(43) Pub. Date: Sep. 10, 2026

(54) CONTROL STRATEGY FOR ELECTRIC MOTOR BASED ALTERNATING CURRENT CHARGING

(71) Applicant: GM GLOBAL TECHNOLOGY OPERATIONS LLC, Detroit, MI (US)

(72) Inventors: Renato Amorim Torres, Pontiac, MI (US); Chandra S. Namuduri, Troy, MI (US); Lei Hao, Shelby Township, MI (US); Peng Peng, Rochester Hills, MI (US); Mohamed Kamel, Birmingham, MI (US)

(73) Assignee: GM GLOBAL TECHNOLOGY OPERATIONS LLC, Detroit, MI (US)

(21) Appl. No.: 19/075,538

(22) Filed: Mar. 10, 2025

(51) Int. Cl. B60L 53/24; B60L 50/60; B60L 53/16; B60L 53/60; H02J 7/00; H02J 7/02

(52) U.S. Cl. CPC B60L 53/24; B60L 50/60; B60L 53/16; B60L 53/60; H02J 7/02; H02J 7/865; B60L 2210/10; B60L 2210/30

(57) ABSTRACT

A battery charging system for an electric vehicle including configured for coupling an output of a direct current to direct current converter to a battery, charging an inverter capacitor across an output of an inverter, decoupling a first of a plurality of stator windings from an inverter leg, applying an alternating current to the first of a plurality of stator windings in an electric motor, converting, by the inverter, the alternating current from the remaining plurality of stator windings to a direct current, coupling the direct current from the output of the inverter to an input of the direct current to direct current converter, converting, by the direct current to direct current converter, the direct current to a direct current charge current, and coupling the direct current charge current to the battery.

### INTRODUCTION

The present disclosure generally relates to automotive electrical systems and electric vehicle battery charging systems, and more particularly relates to a method and apparatus to implement a control system for an electric vehicle propulsion system that facilitates battery charging from an external AC power source.

Modern electric vehicles (EVs) offer sustainable and efficient transportation. Powered by electric motors, EVs deliver instant torque, resulting in smooth and responsive acceleration. Electric motors are used in EVs to convert electrical energy from the battery into mechanical energy to turn the wheels. Typically, there are two main types of electric motors used in EVs: induction motors and permanent magnet synchronous motors (PMSMs). Induction motors are the most common type of electric motor used in EVs as they are very efficient, and they can provide a high torque output. PMSMs are often used in high-performance EVs, such as sports cars and racing cars. Modern EVs typically have two electric motors, one for each axle, but some EVs can have a single motor located under the hood or four motors, one for each wheel, or three motors or a combination thereof. Regenerative braking technology further enhances efficiency by capturing kinetic energy during deceleration and converting it into electricity. As battery technology advances, EVs are becoming increasingly practical for everyday use, with longer ranges, faster charging times, and lower maintenance costs. The expanding charging infrastructure provides convenience and peace of mind, making EV ownership more accessible than ever before.

Electric vehicle on-board battery charging equipment (OBC) is a component of the electric vehicle charging process which converts alternating current (AC) power from the grid into direct current (DC) power that can be directly absorbed by the vehicle's battery. The OBC regulates the charging rate, ensuring optimal battery health and longevity. OBCs are designed to be highly efficient, minimizing energy loss during the charging process. This not only reduces the overall charging time but also contributes to lower energy consumption and a smaller environmental footprint. It is desirable to continue to improve the OBC to improve EV efficiency and convenience. Furthermore, other desirable features and characteristics of the present disclosure will become apparent from the subsequent detailed description and the appended claims, taken in conjunction with the accompanying drawings and the foregoing technical field and background.

### SUMMARY

Disclosed herein are vehicle propulsion methods, systems and related electrical systems for charging electric vehicle batteries, methods for making and methods for operating such systems, and motor vehicles and other equipment such as aircraft, trucks, buses, forklifts, construction vehicles and other electric vehicles equipped with auxiliary power outlets. By way of example, and not limitation, there are presented various embodiments of systems for providing an exemplary electric vehicle charging system.

In accordance with an aspect of the present disclosure, a method of controlling a battery charger in an electric drive system including decoupling, by a first plurality of switches, a battery from an output of an inverter, coupling, by a second plurality of switches, an output of a direct current to direct current converter to the battery, charging, by the battery and the direct current to direct current converter, an inverter capacitor across an output of the inverter, applying an alternating current to the first of a plurality of stator windings in an electric motor, converting, by the inverter, the alternating current from the remaining plurality of stator windings to a direct current, coupling the direct current from the output of the inverter to an input of the direct current to direct current converter, converting, by the direct current to direct current converter, the direct current to a direct current charge current, and coupling the direct current charge current to the battery.

In accordance with another aspect of the present disclosure, wherein the alternating current is a one phase alternating current received from an external source.

In accordance with another aspect of the present disclosure, further including isolating, by a third plurality of switches, the alternating current from the first of the plurality of stator windings and a diode pair coupled to across an input of the direct current to direct current converter and charging the inverter capacitor with the battery and then coupling the alternating current to the first of the plurality of stator windings and the diode pair in response to the inverter capacitor being charged to a voltage exceeding a voltage of the alternating current.

In accordance with another aspect of the present disclosure, including isolating, by a third plurality of switches, the alternating current from the first of the plurality of stator windings and a plurality of metal-oxide-semiconductor field-effect transistors coupled across an input of the direct current to direct current converter and charging the inverter capacitor with the battery and then coupling the alternating current to the first of the plurality of stator windings and the plurality of metal-oxide-semiconductor field-effect transistors in response to the inverter capacitor being charged to a voltage exceeding a voltage of the alternating current.

In accordance with another aspect of the present disclosure, wherein the inverter is further operative to generate a blanking interval in a pulse width modulated signal in response to a grid voltage being below a predetermined threshold.

In accordance with another aspect of the present disclosure, further including regulating, by a proportional-integral regulator, a power factor correction of the alternating current from the inverter.

In accordance with another aspect of the present disclosure, wherein the inverter is configured to convert the alternating current in response to a pulse width modulated interleaving on each of the remaining plurality of stator windings such that each of a plurality of switching signals is time shifted.

In accordance with another aspect of the present disclosure, wherein a pre-charge resistor is employed to pre-charge the inverter capacitor before coupling the alternating current from an external power source to the first of the plurality of stator windings.

In accordance with another aspect of the present disclosure, further including generating a plurality of pulse width modulated control signal for controlling the inverter, wherein the inverter includes a first inverter leg and an extra inverter leg, and synchronizing the plurality of pulse width modulated control signals for the extra inverter leg with a voltage of the alternating current to prevent forward biasing a plurality of inverter diodes within the first inverter leg, wherein a synchronization is achieved using a discontinuous pulse width modulated strategy, including treating one of the plurality of stator windings as a first phase and injecting a zero sequence component into a duty cycle of the first inverter leg and the extra inverter leg.

In accordance with another aspect of the present disclosure, an electric drive system including a battery, wherein the battery is charged in response to a direct current charge current, an input for receiving an alternating current from an external power source, an electric motor having a plurality of stator windings wherein the alternating current is coupled to a first of the plurality of stator windings and is first conducted through the first of the plurality of stator windings to a neutral point, the alternating current is next conducted from the neutral point through the remaining plurality of stator windings in parallel to the inverter, an inverter for converting the alternating current received from the remaining plurality of stator windings to a direct current in response to an inverter control signal, a direct current to direct current converter for converting the direct current to the direct current charge current, a first switch for coupling an output of the battery to the inverter when the electric drive system is in a propulsion mode and decoupling the battery from the inverter when the electric drive system is in a charging mode, and a second switch for coupling an output of the direct current to direct current converter to the battery when the electric drive system is in the charging mode and for decoupling the output of the direct current to direct current converter from the battery when the electric drive system is in the propulsion mode.

In accordance with another aspect of the present disclosure, wherein the alternating current is a one phase alternating current.

In accordance with another aspect of the present disclosure, a third switch for isolating the first of the plurality of stator windings from the inverter.

In accordance with another aspect of the present disclosure, an input switch for isolating the input from the electric motor and a plurality of metal-oxide-semiconductor field-effect transistors coupled across an input of the direct current to direct current converter.

In accordance with another aspect of the present disclosure, an inverter capacitor coupled across an input of the inverter and wherein the electric drive system is configured to energize the inverter capacitor to a voltage higher than a voltage of the alternating current from the external power source by coupling a direct current battery current from the battery to the inverter capacitor before coupling the alternating current from the external power source to the plurality of stator windings.

In accordance with another aspect of the present disclosure, wherein the inverter is further operative to generate a blanking interval in the direct current in response to a magnitude of the alternating current being below a predetermined threshold.

In accordance with another aspect of the present disclosure, wherein the inverter is configured to convert the alternating current in response to a pulse width modulated interleaving on each of the remaining plurality of stator windings such that each of a plurality of switching signals is time shifted.

In accordance with another aspect of the present disclosure, wherein a pre-charge resistor is employed to pre-charge an inverter capacitor before coupling the alternating current from the external power source to the plurality of stator windings

In accordance with another aspect of the present disclosure, wherein a proportional-integral regulator is employed to regulate a power factor correction of the direct current from the inverter.

In accordance with another aspect of the present disclosure, a battery charger in an electric drive system for an electric vehicle including a charge port for receiving an alternating current from an external power source, an electric motor having a plurality of stator windings wherein the alternating current is coupled to a first of the plurality of stator windings and is first conducted through the first of the plurality of stator windings to a neutral point, the alternating current is next conducted from the neutral point through the remaining plurality of stator windings in parallel to the inverter, an inverter for converting the alternating current received from the remaining plurality of stator windings to a direct current in response to an inverter control signal, an inverter controller for controlling the inverter in response to a pulse width modulated interleaving algorithm such that the direct current is converted from the alternating current each of the remaining plurality of stator windings at a plurality of consecutive time intervals and wherein the inverter is further operative to generate a blanking interval in the direct current in response to a magnitude of the alternating current being below a predetermined threshold, a transformer for transforming the direct current to a direct current charging current, and a battery, wherein the battery is charged in response to the direct current charging current.

In accordance with another aspect of the present disclosure, a first switch for coupling an output of the battery to the inverter when the electric drive system is in a propulsion mode and decoupling the battery from the inverter when the electric drive system is in a charging mode, and a second switch for coupling an output of the transformer to the battery when the electric drive system is in the charging mode and for decoupling the output of the transformer from the battery when the electric drive system is in the propulsion mode, a proportional-integral regulator configured to regulate a power factor correction of the direct current from the inverter, and an inverter capacitor coupled across an input of the inverter and wherein the electric drive system is configured to energize the inverter capacitor to a voltage higher than a voltage of the alternating current from the external power source by coupling a direct current from the battery to the inverter capacitor before coupling the alternating current from the external power source to the plurality of stator windings.

### BRIEF DESCRIPTION OF THE DRAWINGS

The exemplary embodiments will hereinafter be described in conjunction with the following drawing figures, wherein like numerals denote like elements, and wherein:

FIG. 1 shows a control system associated with a vehicle in accordance with various embodiments;

FIG. 2 shows an exemplary electric vehicle charging system including a control system for an electric vehicle propulsion system to facilitate battery charging from an external alternating current power source in accordance with various embodiments;

FIG. 3 shows an exemplary electric vehicle charging system with an electric motor and a direct current to direct current converter in accordance with various embodiments;

FIG. 4 shows an exemplary onboard charging module in accordance with various embodiment of the present disclosure; and

FIG. 5 shows a flowchart illustrative of a method for relay coordination and pre-charging strategy for an onboard charging module in accordance with various embodiments.

### DETAILED DESCRIPTION

The following detailed description is merely exemplary in nature and is not intended to limit the application and uses. Furthermore, there is no intention to be bound by any expressed or implied theory presented in the preceding technical field, background, brief summary, or the following detailed description. As used herein, the term “module” refers to any hardware, software, firmware, electronic control component, processing logic, and/or processor device, individually or in any combination, including without limitation: application-specific integrated circuit (ASIC), a field-programmable gate array (FPGA), an electronic circuit, a processor (shared, dedicated, or group) and memory that executes one or more software or firmware programs, a combinational logic circuit, and/or other suitable components that provide the described functionality.

Embodiments of the present disclosure may be described herein in terms of functional and/or logical block components and various processing steps. It should be appreciated that such block components may be realized by any number of hardware, software, and/or firmware components configured to perform the specified functions. For example, an embodiment of the present disclosure may employ various integrated circuit components, e.g., memory elements, digital signal processing elements, logic elements, lookup tables, or the like, which may carry out a variety of functions under the control of one or more microprocessors or other control devices. In addition, those skilled in the art will appreciate that embodiments of the present disclosure may be practiced in conjunction with any number of systems and that the systems described herein are merely exemplary embodiments of the present disclosure.

For the sake of brevity, conventional techniques related to signal processing, data transmission, signaling, control, machine learning, image analysis, and other functional aspects of the systems (and the individual operating components of the systems) may not be described in detail herein. Furthermore, the connecting lines shown in the various figures contained herein are intended to represent example functional relationships and/or physical couplings between the various elements. It should be noted that many alternative or additional functional relationships or physical connections may be present in an embodiment of the present disclosure.

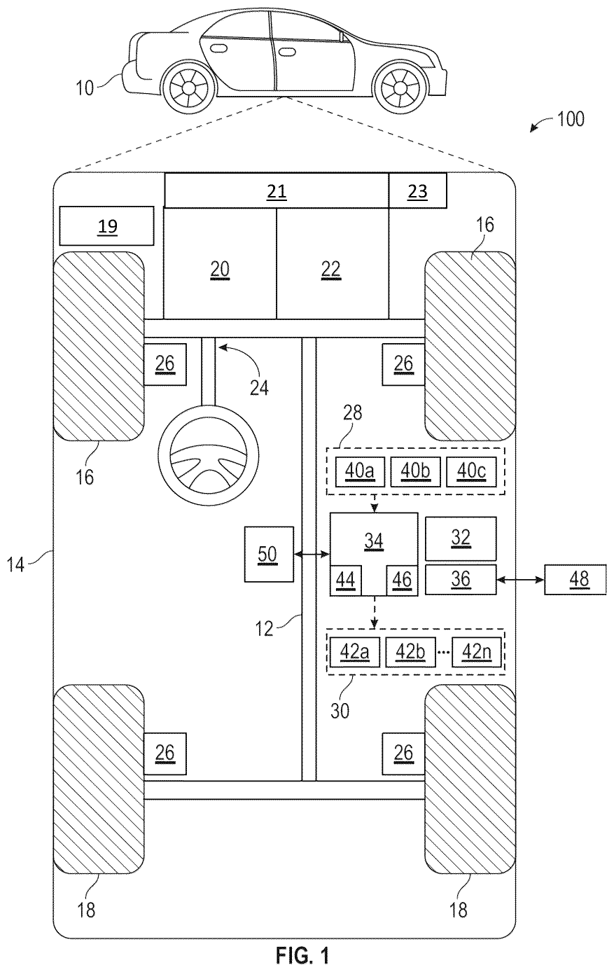

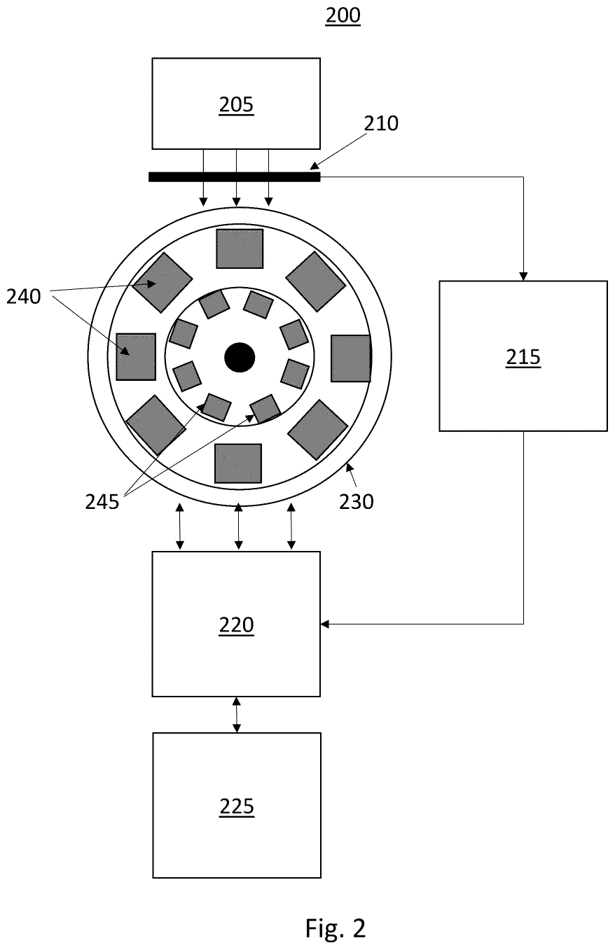

With reference to FIG. 1, a control system 100 is associated with a vehicle 10 (also referred to herein as a “host vehicle”) in accordance with various embodiments. In general, the control system (or simply “system”) 100 provides for control of various actions of the vehicle 10 (e.g., torque control) established by Reinforcement Learning (RL) which is or can be stored in a deep neural network (DNN) type model that controls operation in response to data from vehicle inputs, for example, as described in greater detail further below in connection with FIGS. 2-4.

In various exemplary embodiments, system 100 provides a process using an algorithm that controls torque and speed in a host vehicle's 10 embedded controller software of the system 100 allowing DNN to be used for a automated cruise control behavior prediction model. The system 100 enables learning of driver's preference for following distance for different vehicles such a target vehicle and to classify driver's preference based on driving scenarios; e.g., traffic signs, stop and go traffic, city driving, and the like. The system 100 uses a quadrature matrix to build a knowledge base for target vehicles following a performance preference by utilizing online and historical driver and environmental information.

As depicted in FIG. 1, vehicle 10 generally includes a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, vehicle 10 is autonomous or semi-autonomous, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

As shown, the vehicle 10 generally includes a propulsion system 20, a transmission system 22, a steering system 24, a brake system 26, a canister purge system 31, one or more user input devices 27, a sensor system 28, an actuator system 30, at least one data storage device 32, at least one controller 34, and a communication system 36. The propulsion system 20 may, in various embodiments, an electric machine such as a traction motor, a battery 21, an inverter 19 for converting DC current from the battery to alternating current (AC) current to be supplied to the electric machine, and an on board charger (OBC) 23 for converting AC current from an external power source to a DC current to be used to charge the battery 21. The transmission system 22 is configured to transmit power from the propulsion system 20 to the vehicle wheels 16 and 18 according to selectable speed ratios. According to various embodiments, the transmission system 22 may include a step-ratio automatic transmission, a continuously-variable transmission, or other appropriate transmissions.

The brake system 26 is configured to provide braking torque to the vehicle wheels 16 and 18. Brake system 26 may, in various embodiments, include friction brakes, brake by wire, a regenerative braking system such as an electric machine, and/or other appropriate braking systems.

The steering system 24 influences the position of the vehicle wheels 16 and/or 18. While depicted as including a steering wheel for illustrative purposes, in some embodiments contemplated within the scope of the present disclosure, the steering system 24 may not include a steering wheel.

The controller 34 includes at least one processor 44 (and neural network 33) and a computer-readable storage device or media 46. As noted above, in various embodiments, the controller 34 (e.g., the processor 44 thereof) provides data pertaining to a projected future path of the vehicle 10, including projected future steering instructions, to the steering control system 84 in advance, for use in controlling steering for a limited period of time in the event that communications with the steering control system 84 become unavailable. Also, in various embodiments, the controller 34 provides communications to the steering control system 84 via the communication system 36 described further below, for example, via a communication bus and/or transmitter (not depicted in FIG. 1).

In various embodiments, controller 34 includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store multiple neural networks, along with various operating variables, while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

As depicted in FIG. 1, the vehicle 10 generally includes, in addition to the above-referenced steering system 24 and controller 34, a chassis 12, a body 14, front wheels 16, and rear wheels 18. The body 14 is arranged on the chassis 12 and substantially encloses components of the vehicle 10. The body 14 and the chassis 12 may jointly form a frame. The wheels 16-18 are each rotationally coupled to the chassis 12 near a respective corner of the body 14. In various embodiments, the wheels 16, 18 include a wheel assembly that also includes respectively associated tires.

In various embodiments, the vehicle 10 is an autonomous vehicle, and the control system 100, and/or components thereof, are incorporated into the vehicle 10. The vehicle 10 is, for example, a vehicle that is automatically controlled to carry passengers from one location to another. The vehicle 10 is depicted in the illustrated embodiment as a passenger car, but it should be appreciated that any other vehicle, including motorcycles, trucks, sport utility vehicles (SUVs), recreational vehicles (RVs), marine vessels, aircraft, and the like, can also be used.

The controller 34 includes a vehicle controller that operates based on the neural networks 33 model's output. In an exemplary embodiment, a feed-forward operation can be applied for an adjustment factor that is the continuous output of the neural network 33 models to generate a control action for the desired torque or other like action (in case of a continuous neural network 33 models, for example, the continuous prediction values are outputs).

In various embodiments, one or more user input devices 27 receive inputs from one or more passengers (and driver 11) of the vehicle 10. In various embodiments, the inputs include a desired destination of travel for the vehicle 10. In certain embodiments, one or more input devices 27 include an interactive touch-screen in the vehicle 10. In certain embodiments, one or more input devices 27 include a speaker for receiving audio information from the passengers. In certain other embodiments, one or more input devices 27 may include one or more other types of devices and/or maybe coupled to a user device (e.g., smartphone and/or other electronic devices) of the passengers.

The sensor system 28 includes one or more sensors 40a-40n that sense observable conditions of the exterior environment and/or the interior environment of the vehicle 10. The sensors 40a-40n include but are not limited to, radars, lidars, global positioning systems, optical cameras, thermal cameras, ultrasonic sensors, inertial measurement units, and/or other sensors.

The actuator system 30 includes one or more actuators 42a-42n that control one or more vehicle features such as, but not limited to, canister purge system 31, the intake system 38, the propulsion system 20, the transmission system 22, the steering system 24, and the brake system 26. In various embodiments, vehicle 10 may also include interior and/or exterior vehicle features not illustrated in FIG. 1, such as various doors, a trunk, and cabin features such as air, music, lighting, touch-screen display components (such as those used in connection with navigation systems), and the like.

The data storage device 32 stores data for use in automatically controlling the vehicle 10, including the storing of data of a DNN that is established by the RL, used to predict a driver behavior for the vehicle control. In various embodiments, the data storage device 32 stores a machine learning model of a DNN and other data models established by the RL. The model established by the RL can take place for a DNN behavior prediction model or RL established model (See. FIG. 2, DNN prediction model or RL prediction model). In an exemplary embodiment, no separate training is required for the DNN rather, the DNN behavior prediction model (i.e., DNN prediction model) is implemented with a set of learned functions. In various embodiments, the neural network (i.e., DNN behavior prediction model) may be established by RL or trained by a supervised learning methodology by a remote system and communicated or provisioned in vehicle 10 (wirelessly and/or in a wired manner) and stored in the data storage device 32. The DNN behavior prediction model can also be trained via supervised or unsupervised learning based on input vehicle data of a host vehicle operations and/or sensed data about a host vehicles operating environment.

The data storage device 32 is not limited to control data, as other data may also be stored in the data storage device 32. For example, route information may also be stored within data storage device 32—i.e., a set of road segments (associated geographically with one or more of the defined maps) that together define a route that the user may take to travel from a start location (e.g., the user's current location) to a target location. As will be appreciated, the data storage device 32 may be part of controller 34, separate from controller 34, or part of controller 34 and part of a separate system.

Controller 34 implements the logic model established by reinforced learning (RL) or for the DNN based on the DNN behavior model that has been trained with a set of values, includes at least one processor 44 and a computer-readable storage device or media 46. The processor 44 may be any custom-made or commercially available processor, a central processing unit (CPU), a graphics processing unit (GPU), an auxiliary processor among several processors associated with the controller 34, a semiconductor-based microprocessor (in the form of a microchip or chipset), any combination thereof, or generally any device for executing instructions. The computer-readable storage device or media 46 may include volatile and non-volatile storage in read-only memory (ROM), random-access memory (RAM), and keep-alive memory (KAM), for example. KAM is a persistent or non-volatile memory that may be used to store various operating variables while the processor 44 is powered down. The computer-readable storage device or media 46 may be implemented using any of a number of known memory devices such as PROMs (programmable read-only memory), EPROMs (electrically PROM), EEPROMs (electrically erasable PROM), flash memory, or any other electric, magnetic, optical, or combination memory devices capable of storing data, some of which represent executable instructions, used by the controller 34 in controlling the vehicle 10.

The instructions may include one or more separate programs, each of which includes an ordered listing of executable instructions for implementing logical functions. The instructions, when executed by the processor 44, receive and process signals from the sensor system 28, perform logic, calculations, methods, and/or algorithms for automatically controlling the components of the vehicle 10, and generate control signals that are transmitted to the actuator system 30 to automatically control the components of the vehicle 10 based on the logic, calculations, methods, and/or algorithms. Although only one controller 34 is shown in FIG. 1, embodiments of the vehicle 10 may include any number of controllers 34 that communicate over any suitable communication medium or a combination of communication mediums and that cooperate to process the sensor signals, perform logic, calculations, methods, and/or algorithms, and generate control signals to automatically control features of the vehicle 10.

The communication system 36 is configured to wirelessly communicate information to and from other entities 48, such as but not limited to, other, infrastructure, remote transportation systems, and/or user devices (described in more detail with regard to FIG. 2). In an exemplary embodiment, the communication system 36 is a wireless communication system configured to communicate via a wireless local area network (WLAN) using wireless network protocol or cellular data communication. However, additional or alternate communication methods, such as a dedicated short-range communications (DSRC) channel, are also considered within the scope of the present disclosure. DSRC channels refer to one-way or two-way short-range to medium-range wireless communication channels specifically designed for automotive use and a corresponding set of protocols and standards.

In various embodiments, the communication system 36 is used for communications between the controller 34, including data pertaining to a projected future path of the vehicle 10, including projected future steering instructions. Also, in various embodiments, the communication system 36 may facilitate communications between the steering control system 84 and/or more other systems and/or devices.

In certain embodiments, the communication system 36 is further configured for communication between the sensor system 28, the input device 27, the actuator system 30, one or more controllers (e.g., the controller 34), and/or more other systems and/or devices. For example, the communication system 36 may include any combination of a controller area network (CAN) bus and/or direct wiring between the sensor system 28, the actuator system 30, one or more controllers 34, and/or one or more other systems and/or devices. In various embodiments, the communication system 36 may include one or more transceivers for communicating with one or more devices and/or systems of the vehicle 10, devices of the passengers (e.g., the user device 54 of FIG. 2), and/or one or more sources of remote information (e.g., GPS data, traffic information, weather information, and so on).

Turning now to FIG. 2, an exemplary electric vehicle (EV) charging system including a control system for an electric vehicle propulsion system to facilitate battery charging from an external alternating current power source is shown in accordance with various embodiments. The exemplary EV charging system 200 can include an input 205 for receiving an alternating current (AC) current from an external source, such as a power grid, a sensor 210, an electric motor 230, an inverter 220, an inverter controller 215, and a battery 225.

A key factor in the appeal of EVs is their operational range. To enhance this range, manufacturers implement various energy-saving techniques, including weight reduction. One innovative approach involves leveraging the existing vehicle propulsion system for use in battery charging. By repurposing the vehicle's electric motor 230, inverter controller 215 and inverter 220, which typically convert direct current (DC) battery power to AC power for the electric motor 230, the EV can be equipped with bidirectional charging capability. This enables the vehicle to draw AC power from an external source and convert it back into DC power to charge the battery 225. This eliminates the need for a separate onboard charger, resulting in a significant weight reduction and contributing to improved overall vehicle efficiency and range.

In charging mode, the AC source input 205 is coupled to an external source of AC power, such as a local power grid or the like. In some exemplary embodiments, the external source can provide a three phase AC supply, although the currently described system can be utilized with a single phase AC supply. A sensor 210 can be used to detect the current, voltage and phase of each of the supplied AC currents. This sensor data can then be coupled to the inverter controller 215 for controlling the inverter 220 for converting the AC currents to a DC voltage to be used for charging the battery 225.

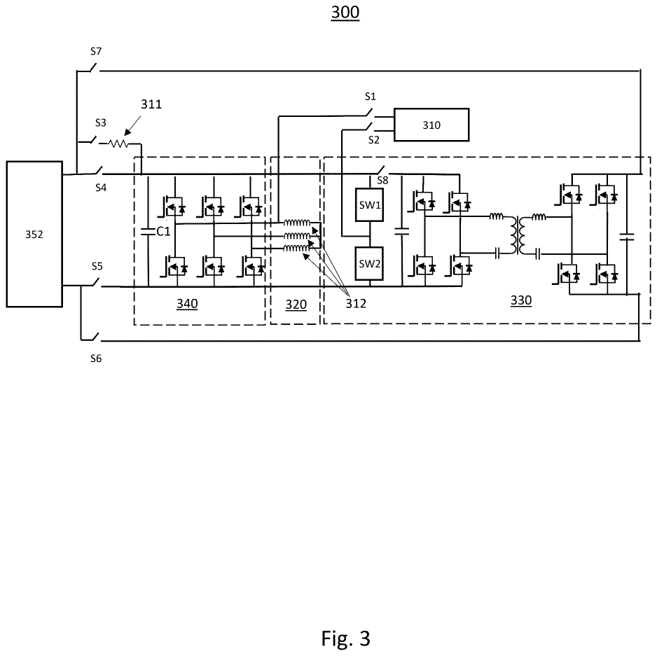

Turning now to FIG. 3, an exemplary EV charging system 300 with an inverter 340, an electric motor 320, a direct current to direct current (DC-DC) converter 330 and an extra inverter leg 350 is shown in accordance with various embodiments. During propulsion mode, switches S4, and S5 are closed, coupling the battery 352 to the inverter 340 and all other switches S1, S2, S3, S6, S7 and S8 are open. The battery 352 serves as the primary energy source, storing electrical energy in the form of chemical potential. The battery 352 typically supplies this energy as direct current (DC). To power the electric motor 320, which generally operates on alternating current (AC), an inverter 340 is employed.

The inverter 340 is configured to operate as an intermediary, converting the DC power from the battery 352 into the necessary three phase AC power for the electric motor 320. The electric motor 320, receives the AC power from the inverter 340. This electrical energy is then transformed into mechanical rotational energy, driving the vehicle's wheels through a transmission system (which may be a simple gear reduction or a more complex system). The motor's speed and torque are controlled by the inverter 340 to allow for smooth acceleration and deceleration. The inverter 340 employs a precisely coordinated switching mechanism, typically using insulated-gate bipolar transistors (IGBTs) or metal-oxide-semiconductor field-effect transistors (MOSFETs), to rapidly switch the DC power from the battery 352 into precisely timed and controlled AC waveforms. These AC waveforms, consisting of three sinusoidal voltages with specific phase shifts, are then supplied to the motor windings 312 of the electric motor 320. By adjusting the phase, frequency and amplitude of these AC signals, the inverter 340 controls the motor's speed and torque, enabling precise acceleration and deceleration essential for efficient EV operation.

In conventional AC charging systems, a dedicated and separate component handles the entire charging process. This component typically includes a rectifier to convert AC grid power to a DC voltage for battery charging. The currently disclosed exemplary EV charging system 300 employs the existing electric motor 320 with the plurality of motor windings 312 and inverter 340 used for vehicle propulsion to perform the rectification function during AC charging. To perform the rectification function an extra inverter leg 350 is also employed. The inverter capacitor C1, the inverter 340 and the extra inverter leg 350 are connected to the DC-DC converter 330 by closing switch S8, enabling the inverter 340 in combination with the auxiliary leg 350 to function as a rectifier. The grid connection is established via the AC input 310 by connecting one output to a first winding of the electric motor 320 by closing switch S1 and the other to the midpoint of the extra inverter leg 350 by closing switch S2. This configuration allows the system to convert AC grid power into DC voltage. The battery 352 is connected at the output of the DC-DC converter 330 by closing switches S7 and S6.

In some exemplary embodiments, it is desirable to pre-charge the inverter capacitor C1 in order to prevent high amperage current rushes into the circuit. Pre-charging the capacitor gradually limits the inrush current, allowing the inverter to operate safely and reliably. In some embodiments, a pre-charge resistor 311 can be employed to couple the battery to the high voltage bus by closing a second plurality of switches S3, S5 to connect the battery output to the inverter capacitor C1, depending on the RESS SOC/Voltage, to charge the inverter capacitors.

In some exemplary embodiments, it is desirable to disconnect the DC-DC converter 330 to prevent currents from flowing across the capacitor C2 while propulsion, potentially extending the capacitor C2 life. In some embodiments, a switch S8 can be employed to disconnect the DC-DC converter 330 capacitor C2.

During AC charging operation, switches S3, S4 and S5 are opened and S6, and S7 are closed, connecting the input of the battery 352 to the output of the DC-DC converter 330 and disconnecting the inverter 340 and the electric motor 320 from the battery 352. In addition switch S8 is closed connecting input of the DC-DC converter 330 to the inverter 340 and extra inverter leg 350. The currents from the stator windings 312 are coupled to the inverter 340 and extra inverter leg 350 for rectification from AC currents to DC currents. These DC currents can then be coupled to the DC-DC converter 330 for transformation to a DC value suitable for charging the EV battery 352. The switches S1-S8 are configured to facilitate the coupling of the transformed DC voltage to the battery 352 and isolation of the battery 352 from the inverter 340 during charging mode and coupling the battery 352 to the inverter 340 and isolation from the DC-DC converter 330 during propulsion mode. The return path is provide by a pair of switching devices SW1, SW2 of the extra inverter leg 350, such as a diode pair and is coupled to the AC input 310 via a second switch S2. In some exemplary embodiments, the pair of switching devices SW1, SW2 can be a pair of MOSFETs, IGBTs, or other switching circuitry.

In some exemplary embodiments, the switching mechanism of the inverter 340 and the extra inverter leg 350 is further configured to generate a blanking interval for the PWM signals such that there is no switching event near zero crossing of the grid voltage. The blanking interval prevents short circuiting the AC input through the extra inverter leg 350 connected to AC input 310 via a second switch S2 and through the leg of the inverter 340 connected to AC input 310 via a first switch S1. The minimum blanking interval can be estimated based on the grid frequency, grid voltage and the control loop delay.

In some exemplary embodiments, the PWM signals of the leg of the inverter 340 connected to AC input 310 via a first switch S1 can be continuously left in off state such that there is no switching event in this leg.

In some exemplary embodiments, a control logic for creating the gate commands for switches SW1 and SW2, which are in sync with grid voltage, can be employed. The synchronization prevents short circuiting the AC input through the extra inverter leg 350 connected to AC input 310 via a second switch S2 and through the leg of the inverter 340 connected to AC input 310 via a first switch S1. Alternatively, the switches SW1, SW2 can be left off.

In some exemplary embodiments, the control logic for the phase windings current regulation during charging incorporates a feedforward mechanism for zero sequence voltage commands. The zero sequence can be calculated to ensure the synchronization of switches SW1 and SW2 with the grid voltage.

Interleaved operation can be employed to minimize motor losses. The unified control framework can be adapted for both AC charging and AC discharging by simply adjusting the polarity of the current command.

The onboard charging module can be configured with several crucial control techniques. Firstly, the onboard charging module can operate in synchronization with the grid voltage to ensure stable grid connection and power transfer. This typically involves a phase-locked loop to extract the grid's frequency and phase information.

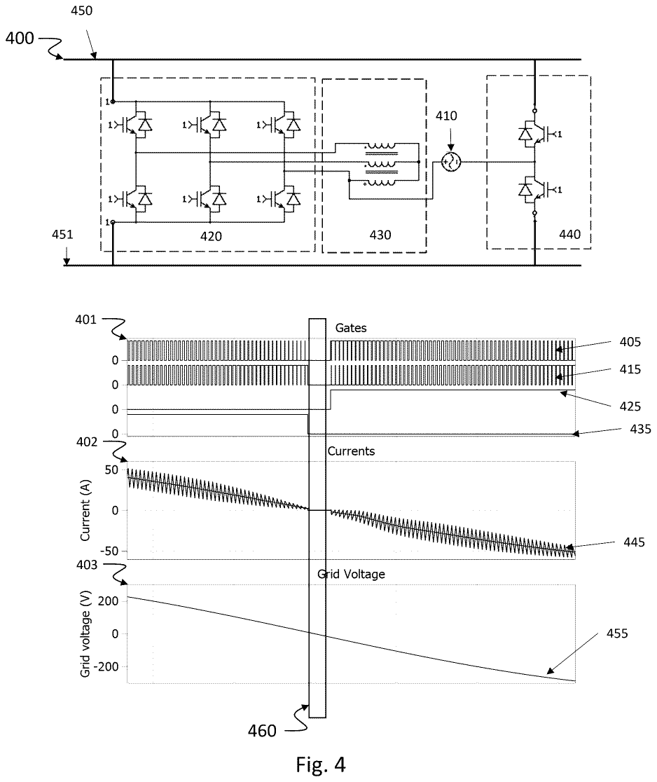

Turning now to FIG. 4, an exemplary onboard charging module (OBCM) 400 according to an exemplary embodiment of the present disclosure is shown. The OBCM 400 can include an inverter 420, an electric motor 430 having a plurality of windings, an AC power source 410, and a transistor pair 440. In charging mode, the inverter 420 is configured to couple a DC current to a DC to DC converter via a positive voltage bus bar 450 and a neutral bus bar 451. In some exemplary embodiments, the OBCM can be the power factor correction stage of the OBCM. Power factor correction is a technique used in electrical power systems to improve the power factor, which is the ratio of real power to apparent power.

A first graph 401 illustrative of a first pulse width modulated (PWM) voltage 405 being conducted through a first set of switches in the inverter 420 and a second PWM voltage 415 being conducted through a second set of switches in the inverter 420. A first switching signal 425 is used to switch the first set of switches of the transistor pair 440 and a second switching signal 435 is used to switch the second set of switches of the transistor pair 440. The resulting current 445 is illustrated in the second graph and the grid voltage 455 being illustrated in the third graph 403.

Before connection of the AC power source 410, typically provided by an external, single phase AC power source via a charger input, input coordination between relays and dc-bus capacitor pre-charging controls is desirable to avoid large inrush currents flowing from the AC power source to the dc-bus capacitor.

It is desirable for optimal operation of the OBCM 400 to ensure robust grid synchronization and protection measures. Firstly, proper relay coordination is desired during the pre-charging phase to reduce high current levels at startup. A pre-charging strategy can be used to mitigate high inrush currents into the system. Secondly, to prevent excessive inrush currents and safeguard power devices, the system can incorporate a control logic at enable a blanking interval 460 that strictly prohibits any switching events in the vicinity of the grid voltage zero-crossing points. This blanking interval 460 should adjust based on grid frequency and voltage levels and control loop delay to ensure optimal operation while minimizing system losses.

The PWM synchronization with the grid voltage is desired to avoid high currents through the AC source 410 while charging. These high currents can occur, for example, if the top switch of the extra inverter leg 440 is ON and the AC source power voltage forward bias the top switch of the inverter leg coupled to the AC input. Therefore, to avoid short-circuiting the AC source the switches of the extra inverter leg 440 need to operate in synchronization with the grid to avoid forward biasing the diodes of the inverter leg coupled to the AC input. To achieve this grid synchronization, a discontinuous PWM (DPWM) strategy can be used which involves treating one of a plurality of motor windings as a first phase and strategically manipulating its operation to ensure precise synchronization with the grid voltage while maintaining compatibility with existing control and modulation techniques. This synchronization can be achieved by injecting a zero sequence component into the duty cycles of all three operating legs (i.e., two legs of the inverter 420 not coupled to the AC input and the extra inverter leg 440). This zero sequence component is used to align the operation of the extra leg with the grid voltage waveform to ensure efficient grid interaction. In the DPWM strategy, the extra inverter leg 440 is treated as a first phase. The inverter leg coupled to the AC input is not operated. The control of the inverter 420 is identical to traditional control strategies up to the modulation stage. The control strategy provides three duty cycles to the modulation block and a zero sequence is added to these duty cycles. The zero sequence is calculated to ensure that extra leg is in sync with the grid.

In some exemplary embodiments, grid voltage 455 shown in the third graph 403 can be feedforwarded to the zero-sequence voltage command. The state (−1 or 1) of the additional leg (multiplied by −Vdc/2) is also feedforward to the zero-sequence voltage command to compensate for the zero-sequence voltage added in series to the machine windings depending on the state of the additional leg

Interleaving involves operating multiple converter phases in parallel with their switching signals phase-shifted from each other. This technique effectively distributes the switching events across the phases, resulting in a significant reduction in the overall current ripple and, consequently, improving input current waveform quality. In addition, by staggering the switching events, interleaving minimizes the peak-to-peak current fluctuations, leading to smoother motor operation with reduced torque ripple and acoustic noise. The number of interleaved phases and the phase shift between them can be optimized to achieve the desired level of input current waveform quality and torque ripple reduction.

PWM interleaving on a three-phase motor refers to a technique where the switching signals for each phase of the electric motor 430 are deliberately shifted in time (phase-shifted) across multiple inverter legs, effectively creating a higher effective switching frequency by overlapping the switching pulses. This technique effectively distributes the switching events across the phases, resulting in a significant reduction in the overall current ripple and, consequently, torque ripple. PWM interleaving smooths out the current waveform by distributing the switching events more evenly across the phases. By distributing switching events across the phases, the current drawn from the power supply becomes smoother, leading to lower ripple in the motor current and improving torque quality. Reduced current ripple translates to less torque ripple. The number of interleaved phases and the phase shift between them can be optimized to achieve the desired level of torque ripple reduction. This technique effectively distributes the switching events across the phases, resulting in a significant reduction in the overall current ripple and, consequently, torque ripple.

The OBCM 400 is configured with a control system for adapting to various operating conditions and modes including implementing control logics for distinct operational phases, such as boost mode operation, stationary reference frame control, and field-oriented control. To optimize system efficiency and minimize losses, the switching frequency and interleaved operation strategies must be dynamically adjusted based on the rotor position.

The OBCM 400 is configured with an unified control approach that enables the OBCM 400 to seamlessly transition between AC charging (G2V) and AC discharging (V2L) modes by simply inverting the polarity of the current command. This unified control strategy enhances system flexibility and simplifies overall operation.

It is desirable to ensure that there will be no torque generated by the electric motor 420 during charging operations even when the rotor position is not aligned with the phase connected to the grid. To avoid this torque generation, a strategy of torque disturbance minimization during motor-inverter based AC charging is employed by minimizing the quadrature axis current component in the machine. The quadrature axis current component is responsible for torque generation. The strategy of torque disturbance minimization can include selecting a switching frequency and interleaved operation can be optimized depending on rotor position. Optimizing switching frequency and employing interleaving techniques can be employed for minimizing torque ripple in the electric motor 430 during AC charging. Higher switching frequencies can reduce torque ripple by minimizing the current ripple within the motor windings as higher frequencies allow for more precise control over the current waveform, leading to a smoother and more consistent torque output. It is desirable to chose an optimal switching frequency to balance the reduction in torque ripple with switching losses. In order to minimize torque disturbance without exceeding twice the AC line input current in the other windings of a three-phase machine, the offset angle between the rotor d-axis and the machine phase coupled to the AC input should be within ±60°. This can be achieved by employing a single-pole triple-throw relay to select one of the three phases for connection to the AC line input. Alternatively, a single-pole double-throw relay can be used to select one of two phases for connection to the AC line input. By strategically switching between these phases, minimum torque disturbance can be maintained regardless of the rotor's position or the offset angle relative to a first phase in a three-phase system with stator terminals.

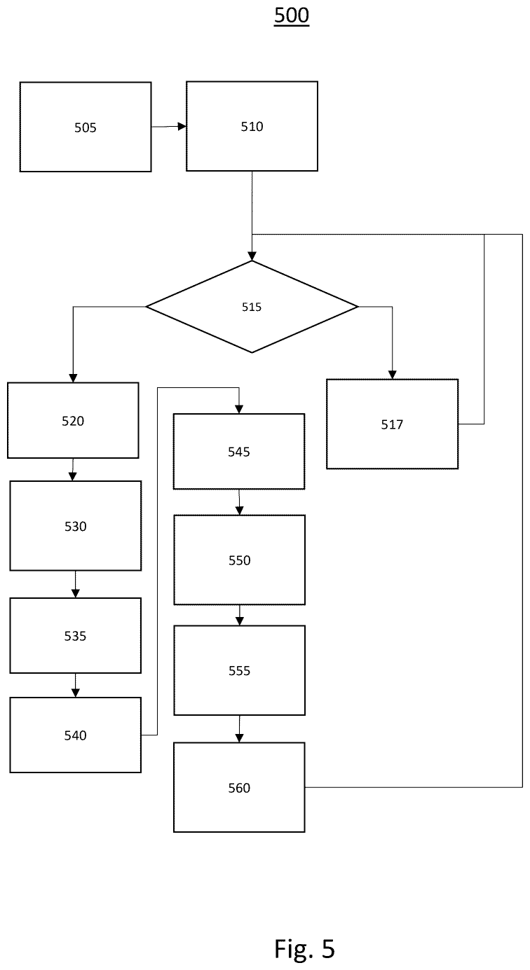

Turning now to FIG. 5, a flowchart illustrating a method 500 for relay coordination and pre-charging strategy for an onboard charging module in accordance with various embodiments is shown. The method 500 is first operative to opening 505 all of the switches in the onboard charging apparatus circuit. The method 500 next charges 510 the inverter capacitors to a voltage higher than the grid voltage utilizing a pre-charge resistor of a high voltage bus by closing a second plurality of switches to connect the battery output to the inverter capacitors, depending on the RESS SOC/Voltage, to charge the inverter capacitors. Alternatively, the method 500 can charge the inverter capacitors using the DC/DC converter in reverse mode.

The method 500 next determines 515 if the electric vehicle will be in charging mode or propulsion mode. If the system is in propulsion mode, the method closes 517 a set of battery switches to couple the battery output to the inverter to enable propulsion. If the system is in charging mode, the method 500 closes 520 a first plurality of switches to connect an output of a DC to DC converter to the battery input.

To start the charging operation, the method 500 next closes 530 a pair of relays to couple the external AC current from an AC input to a neutral point on the onboard charging apparatus. The method 500 closes a first relay to couple the single phase AC signal to a phase of the rotor windings and a second relay to couple the return path from a junction of a pair of diodes spanning the high voltage rails.

In order to regulate the voltage, the method 500 next implements 535 an outer control loop, such as a proportional-integral (PI) regulator, to regulate the power factor correction DC link voltage. In some exemplary embodiments, an outer control loop acts as a higher-level supervisor, setting the target value for the inner control loop. The PI regulator calculates an output signal based on the error between the desired and actual DC-link voltages. This error signal is processed through a proportional term, generating an output directly proportional to the instantaneous error, and an integral term, which integrates the error over time to eliminate steady-state errors. The resulting output signal from the PI regulator is then utilized to adjust the operation of the inner control loop, typically a current controller, which directly regulates the power flow to the DC-link. This hierarchical structure with the PI regulator as the outer loop supervisor ensures stable DC-link voltage, a critical factor for the proper functioning and overall stability of the onboard charging system.

The method 500 next measures 540 the grid voltage using methods like phase lock loop, low pass filter, high pass filter, notch filter, or observer. The method 500 next aligns 545 the grid current reference with the measured grid voltage.

The method 500 can then control 550 the grid current using a grid current controller, such as a PI regulator, and a resonant controller for improved grid frequency component regulation. In some exemplary embodiments, a grid voltage feedforward can be implemented. For legs not synchronized with the grid, the method can interleave them to minimize current ripple and motor losses. For zero sequence voltage injction, the method 500 can perform 555 a three phase electrical signal (abc) to direct axis, quadrature axis and zero sequence (dq0) transformation. Finally, the method 500 can employ 560 a modulation strategy that enables zero-sequence injection. In some exemplary embodiments, the modulation strategy can allow regulation of zero sequence current.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the disclosure in any way. Rather, the foregoing detailed description will provide those skilled in the art with a convenient road map for implementing the exemplary embodiment or exemplary embodiments. It should be understood that various changes can be made in the function and arrangement of elements without departing from the scope of the disclosure as set forth in the appended claims and the legal equivalents thereof.

What is claimed is:

1. A method of controlling a battery charger in an electric drive system comprising:
decoupling, by a first plurality of switches, a battery from an output of an inverter;
coupling, by a second plurality of switches, an output of a direct current to direct current converter to the battery;
charging, by the battery and the direct current to direct current converter, an inverter capacitor across an output of the inverter;
applying an alternating current to the first of a plurality of stator windings in an electric motor;
converting, by the inverter, the alternating current from the remaining plurality of stator windings to a direct current;
coupling the direct current from the output of the inverter to an input of the direct current to direct current converter;
converting, by the direct current to direct current converter, the direct current to a direct current charge current; and
coupling the direct current charge current to the battery.

2. The method of controlling the battery charger in the electric drive system of claim 1, wherein the alternating current is a one phase alternating current received from an external source.

3. The method of controlling the battery charger in the electric drive system of claim 1, further including isolating, by a third plurality of switches, the alternating current from the first of the plurality of stator windings and a pair of switching devices coupled across an input of the direct current to direct current converter and charging the inverter capacitor with the battery and then coupling the alternating current to the first of the plurality of stator windings and the diode pair in response to the inverter capacitor being charged to a voltage exceeding a voltage of the alternating current.

4. The method of controlling the battery charger in the electric drive system of claim 1, further including isolating, by a third plurality of switches, the alternating current from the first of the plurality of stator windings and a plurality of metal-oxide-semiconductor field-effect transistors coupled across an input of the direct current to direct current converter and charging the inverter capacitor with the battery and then coupling the alternating current to the first of the plurality of stator windings and the plurality of metal-oxide-semiconductor field-effect transistors in response to the inverter capacitor being charged to a voltage exceeding a voltage of the alternating current.

5. The method of controlling the battery charger in the electric drive system of claim 1, wherein the inverter is further operative to generate a blanking interval in a pulse width modulated signal in response to a grid voltage being below a predetermined threshold.

6. The method of controlling the battery charger in the electric drive system of claim 1, further including regulating, by a proportional-integral regulator, a power factor correction of the alternating current from the inverter.

7. The method of controlling the battery charger in the electric drive system of claim 1, wherein the inverter is configured to convert the alternating current in response to a pulse width modulated interleaving on each of the remaining plurality of stator windings such that each of a plurality of switching signals is time shifted.

8. The method of controlling the battery charger in the electric drive system of claim 1, wherein a pre-charge resistor is employed to pre-charge the inverter capacitor before coupling the alternating current from an external power source to the first of the plurality of stator windings.

9. The electric drive system of claim 1, further including generating a plurality of pulse width modulated control signals for controlling the inverter, wherein the inverter includes a first inverter leg and an extra inverter leg, and synchronizing the plurality of pulse width modulated control signals for the extra inverter leg with a voltage of the alternating current to prevent forward biasing a plurality of inverter diodes within the first inverter leg, wherein a synchronization is achieved using a discontinuous pulse width modulated strategy, including treating one of the plurality of stator windings as a first phase that will be continuously off and injecting a zero sequence component into a duty cycle of an operating leg.

10. An electric drive system comprising:
a battery, wherein the battery is charged in response to a direct current charge current;
an input for receiving an alternating current from an external power source;
an electric motor having a plurality of stator windings wherein the alternating current is coupled to a first of the plurality of stator windings and is first conducted through the first of the plurality of stator windings to a neutral point, the alternating current is next conducted from the neutral point through the remaining plurality of stator windings in parallel to the inverter;
an inverter for converting the alternating current received from the remaining plurality of stator windings to a direct current in response to an inverter control signal;
a direct current to direct current converter for converting the direct current to the direct current charge current;
a first switch for coupling an output of the battery to the inverter when the electric drive system is in a propulsion mode and decoupling the battery from the inverter when the electric drive system is in a charging mode; and
a second switch for coupling an output of the direct current to direct current converter to the battery when the electric drive system is in the charging mode and for decoupling the output of the direct current to direct current converter from the battery when the electric drive system is in the propulsion mode.

11. The electric drive system of claim 10, wherein the alternating current is a one phase alternating current.

12. The electric drive system of claim 10, further including a third switch for isolating the first of the plurality of stator windings from the inverter.

13. The electric drive system of claim 10, further including an input switch for isolating the input from the electric motor and a plurality of metal-oxide-semiconductor field-effect transistors coupled across an input of the direct current to direct current converter.

14. The electric drive system of claim 10, further including an inverter capacitor coupled across an input of the inverter and wherein the electric drive system is configured to energize the inverter capacitor to a voltage higher than a voltage of the alternating current from the external power source by coupling a direct current battery current from the battery to the inverter capacitor before coupling the alternating current from the external power source to the plurality of stator windings.

15. The electric drive system of claim 10, wherein the inverter is further operative to generate a blanking interval in the direct current in response to a magnitude of the alternating current being below a predetermined threshold.

16. The electric drive system of claim 10, wherein the inverter is configured to convert the alternating current in response to a pulse width modulated interleaving on each of the remaining plurality of stator windings such that each of a plurality of switching signals is time shifted.

17. The electric drive system of claim 10, wherein a pre-charge resistor is employed to pre-charge an inverter capacitor before coupling the alternating current from the external power source to the plurality of stator windings.

18. The electric drive system of claim 10, wherein a proportional-integral regulator is employed to regulate a power factor correction of the direct current from the inverter.

19. A battery charger in an electric drive system for an electric vehicle comprising:
a charge port for receiving an alternating current from an external power source;
an electric motor having a plurality of stator windings wherein the alternating current is coupled to a first of the plurality of stator windings and is first conducted through the first of the plurality of stator windings to a neutral point, the alternating current is next conducted from the neutral point through the remaining plurality of stator windings in parallel to the inverter;
an inverter for converting the alternating current received from the remaining plurality of stator windings to a direct current in response to an inverter control signal;
an inverter controller for controlling the inverter in response to a pulse width modulated interleaving algorithm such that the direct current is converted from the alternating current each of the remaining plurality of stator windings at a plurality of consecutive time intervals and wherein the inverter is further operative to generate a blanking interval in the direct current in response to a magnitude of the alternating current being below a predetermined threshold;
a transformer for transforming the direct current to a direct current charging current; and
a battery, wherein the battery is charged in response to the direct current charging current.

20. The battery charger in the electric drive system for the electric vehicle of claim 19, further including:
a first switch for coupling an output of the battery to the inverter when the electric drive system is in a propulsion mode and decoupling the battery from the inverter when the electric drive system is in a charging mode; and
a second switch for coupling an output of the transformer to the battery when the electric drive system is in the charging mode and for decoupling the output of the transformer from the battery when the electric drive system is in the propulsion mode;
a proportional-integral regulator configured to regulate a power factor correction of the direct current from the inverter; and
an inverter capacitor coupled across an input of the inverter and wherein the electric drive system is configured to energize the inverter capacitor to a voltage higher than a voltage of the alternating current from the external power source by coupling a direct current from the battery to the inverter capacitor before coupling the alternating current from the external power source to the plurality of stator windings.
